(19) United States
(12) Patent Application Publication
(10) Pub. No.: US 2007/0092858 A1
(43) Pub. Date: Apr. 26, 2007

(54) Personal medication dispensing system

(76) Inventors: Qaisar Usmani, West Windsor, NJ (US); Salma Usmani, West Windsor, NJ (US)

Correspondence Address: S Pal Asija, 7 Woonsocket Ave, Shelton, CT, 06484, US

(21) Appl. No.: 11/524,152

(22) Filed: Sep. 20, 2006

Related U.S. Application Data
(60) Provisional application No. 60/728,636, filed on Oct. 20, 2005.

(51) Int. Cl. G09B 23/28

(52) U.S. Cl. 434/262; 604/257

(57) ABSTRACT

This invention teaches methods, devices, and system for relieving or reducing pain by self-injecting liquid pain medicine obviating many expensive visits to the medical professionals. It includes a liquid medicine reservoir and a dispensing device with at least one syringe and a plurality of injection needles interconnected with a conduit comprising a three-way valve. The system also includes, means for metering of medicament and instructions for safe administration thereof. The system is known by its trademark name ARAAM which in Hindustani and URDU means restful comfort.

### RELATED DOCUMENT

This invention is based upon provisional application serial No. 60/728,636 filed Oct. 20, 2005 by the same inventors then titled by its trademark name ARAAM but is conceptually and effectively the same Do-It-Yourself personal pain medication administering system.

### BACKGROUND

This invention relates generally to self health care devices methods and system. More particularly it relates to a Do-It-Yourself novel non-obvious pain medication administration system. Even more particularly it relates to methods, devices and system for relieving or reducing pain by self-injecting liquid pain medicine obviating many expensive visits to the medical professionals. The system is known by its trade name ARAAM which in Hindustani and URDU means restful comfort.

### THE PROBLEM

Unfortunately in recent times there has been an alarming increase in the number of patients suffering from pain. All types of patients suffering in pain expect and must be attended to immediately. It is difficult for physicians and other medical professionals, to attend to each and every patient right away. Their pain in the meantime affects their jobs, daily activities, and most of all their quality of life, leading to many other health issues.

For example, the consequences may lead to psychological problems, which further cause financial loss, whether it is on individual or government level. Such turmoil amongst people would eventually start affecting society generally in a negative way. Overall, there should be a way for people to lessen their pain without seeing a physician every time they have an episode.

The problem with prior art systems devices and procedures is that they are neither effective nor affordable. They require frequent expensive visits to various medical facilities. The deficiencies in the prior art systems, devices and methods may be summarized as follows.
a) Not Effective
b) Expensive
c) Not D-I-Y user friendly
d) Not portable
e) Involve complicated FDA approvals
f) Not adjustable to provide customized relief on specific areas of the body.
g) Not comfortable.
h) Non-Intuitive to use
i) Does not provide symmetrical balanced relief for the entire back area.
j) Not reliable having low MTBF
k) Not even safe

### SUMMARY

This invention teaches methods, devices, and systems for relieving or reducing pain by self-injecting liquid pain medicine obviating many expensive visits to the medical professionals. An embodiment of this pain-relieving device comprises a liquid medicine reservoir and a dispensing device with at least one syringe and a plurality of injection needles interconnected with a conduit comprising a three-way valve. The system also includes, means for metering of medicament and instructions for safe administration thereof.

### PRIOR ART

A preliminary prior art patent search was not conducted or commissioned by the applicant, but the inventor is intimately familiar with the prior art. There are no known D-I-Y liquid pain medication administration systems.

At any rate none of the prior art devices known to the applicant or his attorney disclose the EXACT embodiment of this inventor that constitutes a simple, elegant, quick, convenient, affordable means of self pain medication administration system. Prior art devices do not provide singularly or even in combination all of the objectives as established by the inventor for this system as enumerated below.

### Objectives

1) It is an objective of this invention to provide improved, simplified, time saving, cost effective methods, devices and system for Do-It-Yourself health care.
2) Another objective of this invention is to provide relief from pain
3) An objective on making the device was to construct it as simple as possible and inexpensive as possible without compromising function and durability.
4) Another objective of this device is to be useable by the general public and not fall within the FDA regulatory guidelines of Medical Devices requiring a prescription.
5) Another objective of this invention is to reduce the risk to the user or D-I-Y patient.
6) Another objective of this invention is to promote good health while concurrently reducing cost and the insurance premiums
7) Another objective of this invention is that the design of the device be simple and elegant.
8) Another objective of this invention is that its use is intuitive, which requires no further training beyond what is customary in the profession.
9) Another objective of the system of this invention is that it be capable of multiple uses and multiple situations and circumstances.
10) Another objective of the invention is that it uses minimal additional energy or training.
11) Another objective of this invention is that the invention use easily interface-able modular standard components.
12) Another objective of this invention is that it be reliable such that it practically never fails.
13) Another objective of this invention is that it be environmentally friendly, and utilize biodegradable materials to the extent practical.
14) Another objective of this invention is that it be physically safe in normal environment as well as accidental situations.
15) Another objective of this invention is to provide a cost effective affordable system for patients and professionals alike.
16) Another objective of this invention is to provide an easy and simple way to manufacture the device of this invention.
17) Another objective of this invention is that it balances convenience and functionality especially for the D-I-Y user.
18) Another objective of this invention is that it obviate the need to meet Federal, State, local, and other private, international, standard guidelines, regulations, compliances and recommendations with respect to safety, environment, and energy consumption

Other objectives of this invention reside in its simplicity, elegance of design, ease of manufacture, service and use and even aesthetics as will become apparent from the following brief description of the drawings and the detailed description of the concept embodiment.

Unfortunately none of the prior art devices singly or even in combination provides all of the features and functionality established by the inventor for this system as enumerated below.
a) Balance between convenience and functionality
b) Safe, Secure, Simple and elegant sleek design
c) Affordable and Cost effective
d) Easy to manufacture, use, operate and maintain.
e) User Friendly and Environmentally friendly.
f) Intuitive to use so as to require no or minimal additional training
g) Multiple uses in a wide range of situations and circumstances.
h) Easily scaleable up and down
i) Easily adaptable for other uses

### BREIF DESCRIPTION OF DRAWINGS

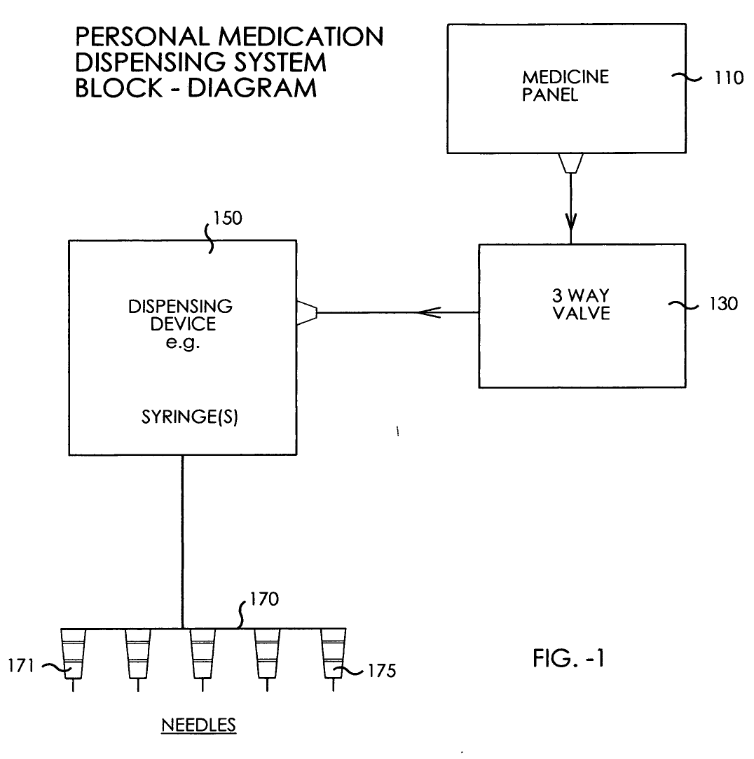

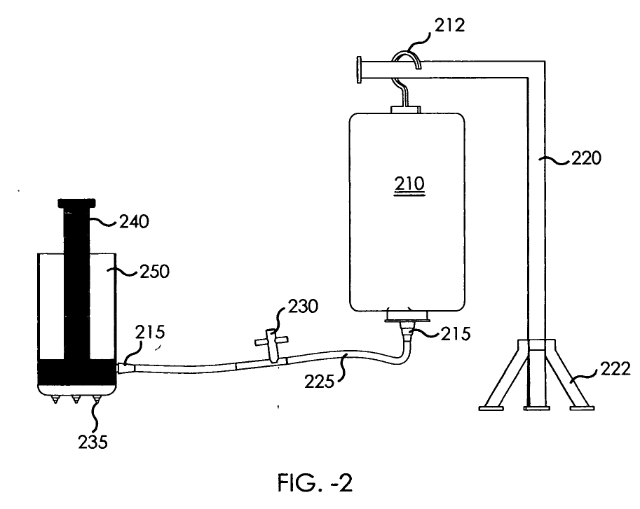

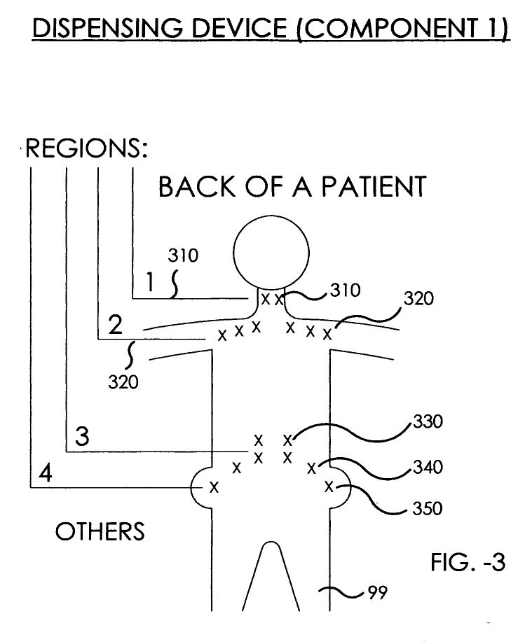

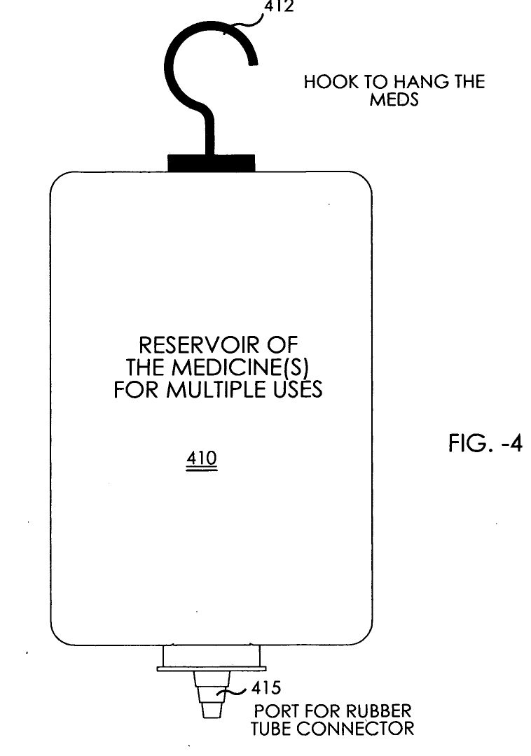

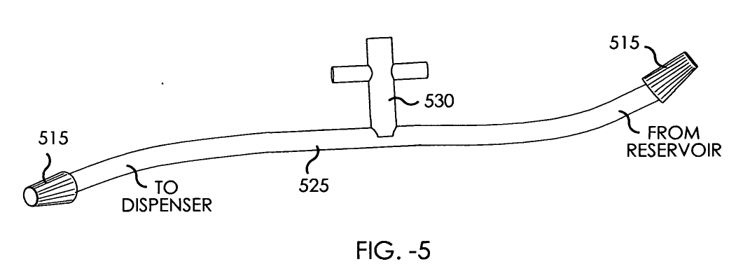

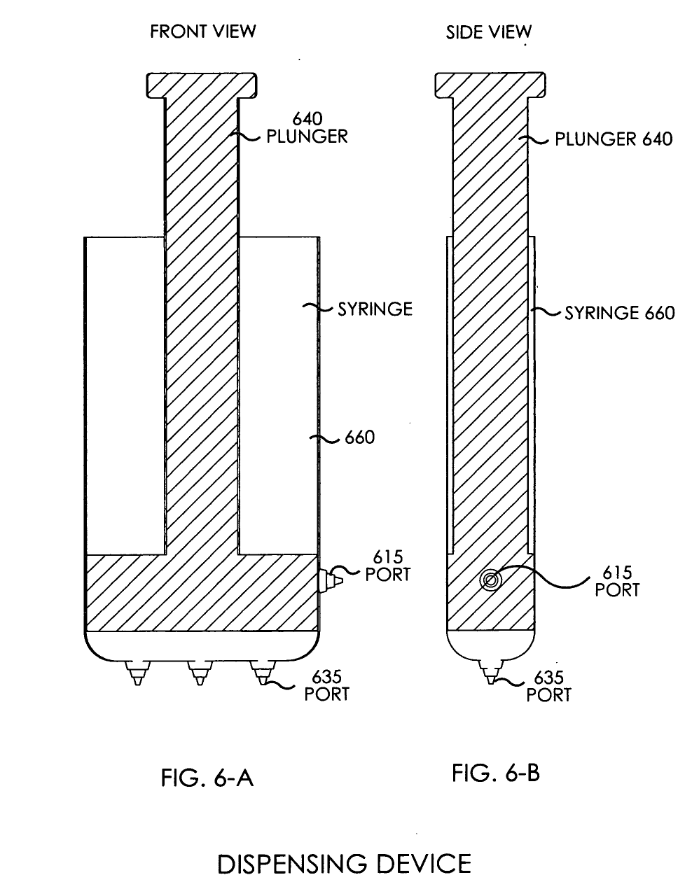

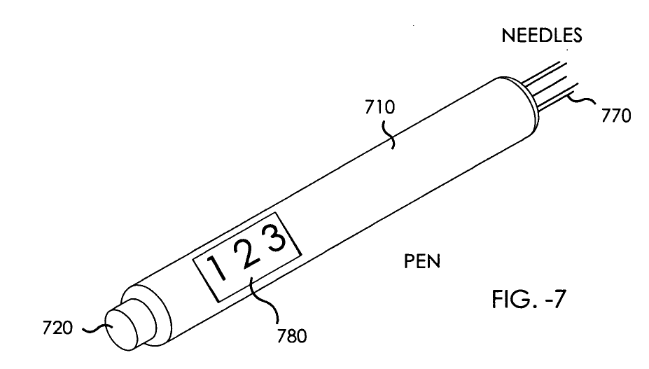

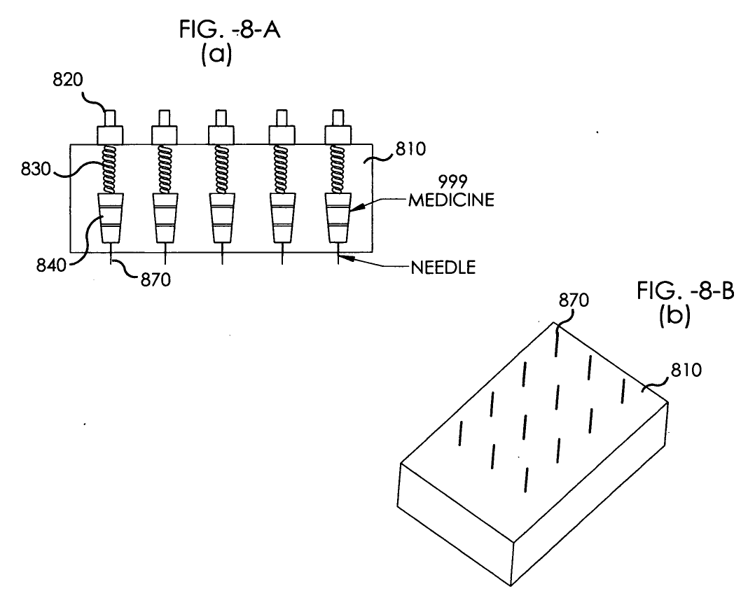

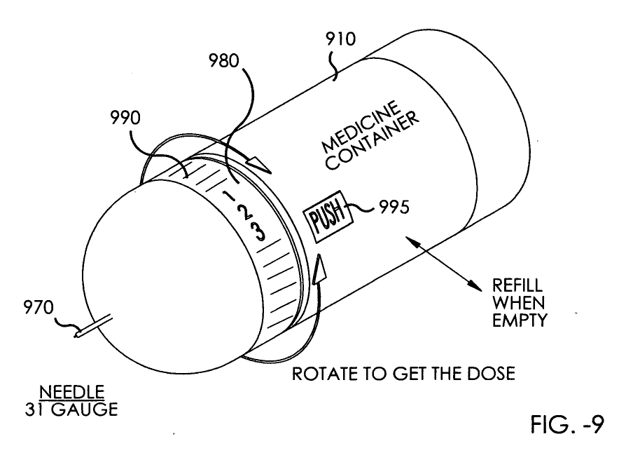

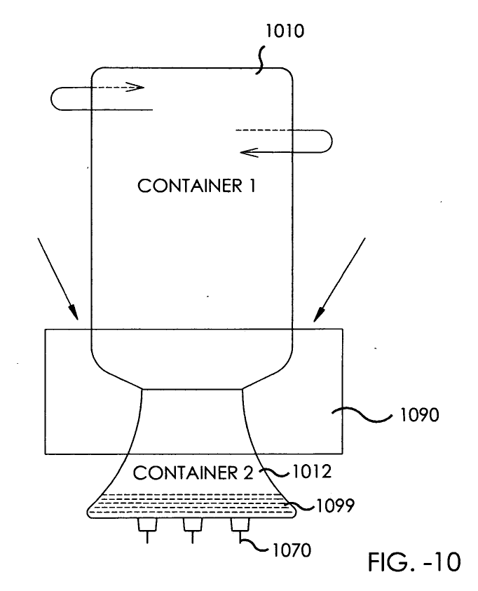

These objectives and features of the invention shall now be described in relationship to the following drawings, which are integral part of the specifications and are incorporated herein. Skilled artisan will be able to produce the intended invention with the most efficient dimensions of any of the embodiments contained within this description.
a) FIG. 1 is a block flow diagram of the personal pain medication dispensing system of an embodiment 100 of this invention of the D-I-Y system for control, relief, reduction and management of pain.
b) FIG. 2 is front view of the personal pain medication dispensing system of this invention.
c) FIG. 3 shows the points and regions of the back of a patient where typically such pain medication is injected.
d) FIG. 4 shows the liquid pain medication reservoir the personal pain medication dispensing system of this invention.
e) FIG. 5 shows a front view of a 3-way valve in a conduit, which connects, paid medication reservoir with the medication-dispensing device.
f) FIG. 6-A shows the front view of the dispensing device the personal pain medication dispensing system of this invention.
g) FIG. 6-B shows side elevation of the dispensing device of the personal pain medication dispensing system of this invention of FIG. 6-A
h) FIG. 7 shows a plan view of an alternate embodiment personal pain medication dispensing system of this invention.
i) FIG. 8-A shows front view of yet another alternate embodiment personal pain medication dispensing system of this invention.
j) FIG. 8-B shows bottom perspective view of the embodiment of FIG. 8-A to delineate the matrix of needles.
k) FIG. 9 shows yet another alternate embodiment personal pain medication dispensing system of this invention.
l) FIG. 10 shows yet another embodiment of personal pain medication dispensing system of this invention.

### DETAILED DESCRIPTION OF THE BEST MODE PREFERRED EMBODIMENT

As shown in the drawings wherein like numerals represent like parts throughout the several views, there is generally disclosed in FIG. 1 is a block flow diagram of the personal pain medication dispensing system of an embodiment 100 of this invention of the D-I-Y system for control, relief, reduction and management of pain complete with medicine panel 110, three way valve 130 in a conduit interconnecting medicine panel 110 to a dispensing device 150 and plurality of injection needles 170.

FIG. 2 is front view of the personal pain medication dispensing system of this invention complete with medicine pouch 210, hanging from a stand 220 via hook 212 at a higher elevation for automatic gravity feed, a three way valve 230 in a conduit 225 connecting pouch 210 via press fit tapered interface 215 to dispensing device 250 such as a syringe having plurality of injection needles 235. The tapered interface 215 on the dispensing end of the syringe is similar to the tapered interface on the medication pouch 210, except for the size differential.

FIG. 3 shows the points and regions of the back of a patient where typically such pain medication is injected specifically showing the back of a patient 99 with following regional points of pain administration. Inter alia Para-cervical C₂ and C₇ areas 310, trapezial area, para-thoracic T₃, T₆ and T₇ areas 320, para-lumbar L4 area 330, sacroiliac joint area 340 and last but not least trochantaric bursa areas 350.

FIG. 4 shows the liquid pain medication reservoir 410 of the personal pain medication dispensing system 400 of this invention complete with a hanging hook 412, and a press fit tapered interface port 415. The medicine reservoir contains a medicine certain (e.g. Lidocaine, Cortisone, etc) needed for multiple uses. It may or may not be hooked to a stand or connected to the dispensing device through the connector during the procedure. These options are guided by individual patient's needs.

FIG. 5 shows a front view of a 3-way valve 530 in a conduit 525, which connects pain medication reservoir with the medication-dispensing device. Each end has a sterile lock-on screw cap, which must be removed just before making the connections.

The reservoir end interface 515 is identical to the dispensing end interface 515. The connector 500 is a conduit system 525 with a three-way valve 530 to allow the influx of the medicine from the reservoir to the dispensing device when needed. It also prevents the efflux of the medicine from the device to the reservoir during the procedure, which may be done multiple times during a session.

FIG. 6-A shows the front view of the dispensing device 600 the personal pain medication dispensing system of this invention complete with a syringe 660 having a plunger 640, a port 615 for connection to the medication reservoir and a plurality of ports 635 for plurality of screw-on needles. Likewise FIG. 6-B also shows side elevation of the dispensing device 600 of the personal pain medication dispensing system of this invention of FIG. 6-A complete with a syringe 660 having a plunger 640, a port 615 for connection to the medication reservoir and a plurality of ports 635 for plurality of screw-on needles.

The dispensing device typically is a syringe with three bores for needles to be screwed on and also a plunger to suck the medicine first from the reservoir through the bore as shown and then push the medicine secondly through the needles to specified pain sites.

In the preferred embodiment the dispensing device itself has the capacity to contain up to eight to ten ml, but no more, to make the pushing of medicine easier. This is because using a larger device (e.g. with a capacity of 24 ml) poses difficulty in pushing the medicine through the thin bore needles and for the same reason a connector is needed for multiple refills during the same session.

FIG. 7 shows a plan view of an alternate pen shaped embodiment personal pain medication dispensing system 700 of this invention complete with body of the pen 710, medicine injection actuator end 720, dispensing end with plurality of injection needles 770 and a counter 780.

FIG. 8-A shows front view of yet another alternate rectangular embodiment 800 personal pain medication dispensing system of this invention complete with rectangular housing body 810, medicine injection actuator 820, spring 830 loaded plurality of syringes 840 each having a dispensing an needle 870. Likewise FIG. 8-B shows bottom perspective view of the embodiment of FIG. 8-A to delineate rectangular body 810 and the matrix of needles 870.

FIG. 9 shows yet another alternate cylindrical embodiment 900 of personal pain medication dispensing system of this invention complete with cylindrical body 910, insert-able injection needle 970, a rotary dial 990 and a push button actuator 995. Rotation of the cap 990 meters and dispenses the right amount of liquid pain medicine. The preferred liquid medications are blue container lidocaine and red container with both cortisone and lidocaine.

FIG. 10 shows yet another embodiment 1000 of personal pain medication dispensing system of this invention complete with a first rotate-able container 1010 containing the liquid paid medication and a second container 1012. Rotation of the first container 1010 with respect to second container 1012 meters and dispenses the right amount of liquid pain medicine from the first container 1010 to the second container 1012. The second container 1012 is interfaced to a plurality of injection needles 1070. Medicine 1099 is pushed by medicine pusher 1090.

### Assembly Use and Opporation

The assembly and use of this invention is intuitive. Nonetheless the inventor recommends the following steps:
a) Educating and training the physicians about the system;
b) Consultation between trained physician and the patient in pain;
c) Educating the patients by providing literature, videos, and an initial demonstration of the procedure at their respective physicians' offices.
d) Selecting the right embodiment and liquid pain medication for the needs of the particular patient.
e) Prescribing and advising the patient about the amount and frequency of medicine to be used at a specific site and the frequency of the procedure to be done.
f) Sterilizing each desired region thoroughly for example with Betadine.
g) Choosing the right bore and right sized needle.
h) The inventor strongly recommends massaging the local area immediately following the procedure.

The sites shown in FIG. 3 are injected with Lidocaine (and/or Cortisone, etc) periodically. In fact it is a breakthrough technique to abate migraine pains and headaches, which are not, relieved by myriad of anti-inflammatory medicines and migraine pills that are presently costing the health care system billions of dollars.

The specified medicine is administered at the injection site 310 at the comfort of home either by the patients themselves or by one of their attendants. Safety and caution of this medicine delivery system is number one priority. To accomplish this, the inventor recommends the following guidelines.

1) Blue label Lidocaine 1% can be safely administered every three days. Up to twenty to twenty-four cc of fluid can be used each day, divided over the pain sites specified.

2) Red Label Cortisone on the other hand admixed with Lidocaine is administered every six to eight weeks, for example, sixty mg of Triamcinolone divided over the pain sites. Local massage therapy immediately following the procedure is strongly recommended, in order to ensure the best results.

3) After the area is sterilized with betadine, I would suggest using up to three or four cc of Blue label Lidocaine 1% in one region.

4) The same procedure is repeated on other regions as well. For convenience, the same needles for multiple regions in one day can be used, but can also be changed, if the patient wishes. The device should dispense up to twenty to twenty-four ml in one day.

5) The needles should be screwed on tightly to the system (Leur lock) so that the pressure of the medicine efflux does not cause the needles to fall off.

6) The needles should be long enough to dispense the medicine as deep as possible for optimal results and should be done without leaving a “bump” on the skin that causes discomfort.

7) The needles should be short enough not to puncture the lungs, abdominal viscera, etc. This is why the suggested length of the needles is five to seven millimeters.

8) The bore of the needles should be minimized to make the needles thin enough to cause minimal discomfort on injections and yet wide enough to ensure a smooth flow of medicine through them.

Note: The inventor in the preferred embodiment used twenty-five to thirty gauge needles.

The inventor has given a non-limiting description of the system of this invention. Due to the simplicity and elegance of the design of this invention designing around it is difficult. Nonetheless many changes may be made to this design without deviating from the spirit of this invention. Examples of such contemplated variations include the following:
a) The color, aesthetics and materials may be enhanced or varied.
b) Additional complimentary and complementary functions and features may be added.
c) A more economical version and/or size of the device may be adapted.
d) A procedural step may be added, deleted or modified.
e) The needle gauge size may be varied to suit the needs of a particular patient.
f) Newer more effective medications may be substituted as they are invented, developed, approved by the FDA and are placed into interstate commerce.
g) Other changes such as aesthetics and substitution of newer materials as they become available, which substantially perform the same function in substantially the same manner with substantially the same result without deviating from the spirit of the invention may be made.

The following is a brief description of the function of the components and procedural steps used in the best mode preferred embodiment for the ready reference of the reader the reference numerals have been arranged in ascending numerical order. The first digit in case of three digit reference numbers or first two digits in case of 4 digit numbers denotes the figure number and the last two digits represent the reference number of the component.
099=Patient generally
100=Embodiment of FIG. 1 generally
110=Liquid pain medicine panel or pouch or container
130=3 Way valve in conduit
150=Dispensing device
170=Needles
200=Embodiment of FIG. 2 generally
210=Liquid pain medicine panel or pouch or container
212=Hook for hanging the pouch
215=Delivery port on medicine pouch and on dispensing device
220=Tripod stand
222=3 Legs of the tripod stand
225=Conduit interconnecting medicine pouch to delivery device
230=3 Way valve in conduit 225
240=plunger of a delivery device such as a syringe
250=Dispensing device
235=Liquid pain medicine delivery ports
300=Back of a patient generally
310=Region—1
320=Region—2
330=Region—3
340=Region—4
400=Embodiment of FIG. 4 generally
410=Red or Blue Label Liquid medicine pouch or container
412=Hook for hanging the pouch
415=Delivery port
500=Embodiment of FIG. 5 generally
515=Connector port on medicine pouch and on dispensing device
525=Conduit interconnecting medicine pouch to delivery device
530=3 Way valve
600=Embodiment of FIG. 6 generally
615=Dispensing device inlet port
635=Needle ports on dispensing device
640=Plunger of dispensing device
660=Delivery device such as a syringe
700=Embodiment of FIG. 7 generally
710=Pen shaped medicine container
720=Actuator means
770=Needles
780=Counter
800=Embodiment of FIG. 8 generally
810=Rectangular container
820=Actuator means
830=Actuator release spring
840=Syringe like delivery device
870=Injection needles
900=Embodiment of FIG. 9 generally
910=Cylindrical medicine container
980=Counter
990=Rotary means to meter medicine
995=Actuator means
999=Refill medicine such as Blue label Lidocaine 1% or Red label Cortisone with both Kea-log and lidocaine
1000=Embodiment of FIG. 10 generally
1010=Rotate-able first cylindrical container
1012=Rotate-able second contoured cylindrical container
1090=Medicine Pusher
1099=Blue label Lidocaine 1% medicine or Red label Cortisone with both cortisone and lidocaine

### Definitions and Acronyms

A great care has been taken to use words with their conventional dictionary definitions. Following definitions are included here for clarification.
3D=Three Dimensional
DIY=Do It Yourself
FDA=Food and Drug Administration of the United States Executive Branch.
Integrated=Combination of two entities to act like one
Interface=Junction between two dissimilar entities
Leur Lock=Locked with threaded screw rather than press fit
MTBF=Mean Time Between Failure
Symmetrical=Mirror image along any axis.

While this invention has been described with reference to illustrative embodiments, this description is not intended to be construed in a limiting sense. Various modifications and combinations of the illustrative embodiments as well as other embodiments of the invention will be apparent to a person of average skill in the art upon reference to this description. It is therefore contemplated that the appended claim(s) cover any such modifications, embodiments as fall within the true scope of this invention.

The inventor claims:

1. A personal medication dispensing system for pain relief comprising:
a) a liquid pain medicine container;
b) a dispensing device;
c) a conduit between said pain medicine container and said dispensing device;
d) a 3-way valve inserted inline in said conduit;
e) at least one syringe interfaced to said dispensing device; and
f) a plurality of needles interface-able to said syringe.

2. The personal medication dispensing system for pain relief of claim 1 wherein:
a) said conduit is a rubber tube;
b) said medicine container has a tapered outlet port for press fit to said conduit;
c) said dispensing device has a tapered inlet port for press fit to said conduit; and
d) said dispensing device has plurality of non-slip screw-on ports for needles.

3. The personal medication dispensing system for pain relief of claim 1 wherein said dispensing device is a syringe.

4. The personal medication dispensing system for pain relief of claim 2 wherein:
a) said conduit is a rubber tube;
b) said medicine container has a tapered outlet port for press fit to said conduit;
c) said dispensing device has a tapered inlet port for press fit to said conduit; and
d) said dispensing device has plurality of non-slip screw-on ports for needles.

5. The personal medication dispensing system for pain relief of claim 1 wherein said liquid medicine comprises blue label Blue label 1% Lidocaine.

6. The personal medication dispensing system for pain relief of claim 1 wherein said liquid medicine comprises red label Cortisone with both cortisone and lidocaine.

7. The personal medication dispensing system for pain relief of claim 1 wherein said liquid medicine is self administer-able.

8. The personal medication dispensing system for pain relief of claim 1 wherein said dispensing device comprises embodiment of FIG. 7

9. The personal medication dispensing system for pain relief of claim 1 wherein said dispensing device comprises embodiment of FIG. 8

10. The personal medication dispensing system for pain relief of claim 1 wherein said dispensing device comprises embodiment of FIG. 10

11. A self help method of liquid medication dispensing system comprising the steps of:
a) educating and training the physicians about the dispensing system;
b) arranging at least one consultation between trained physician and the patient in pain;
c) educating the patient by providing literature, videos, and an initial demonstration of the procedure at the physicians' offices;
d) selecting a dispensing embodiment and liquid pain medication for the needs of the particular patient;
e) prescribing and advising the patient about the amount and frequency of medicine to be used at a specific site and the frequency of the procedure to be done;
f) sterilizing each desired region with beta-dine;
g) choosing the right bore and right sized needle; and
h) massaging the local area immediately following the above procedure.

12. The self-help method of liquid medication dispensing system of claim 11 wherein said dispensing system comprises:
a) a liquid pain medicine container;
b) a dispensing device;
c) a conduit between said pain medicine container and said dispensing device;
d) a 3-way valve inserted inline in said conduit;
e) at least one syringe interfaced to said dispensing device;
f) a plurality of needles interface-able to said syringe; and wherein
e) said conduit is a rubber tube;
f) said medicine container has a tapered outlet port for press fit to said conduit;
g) said dispensing device has a tapered inlet port for press fit to said conduit; and
h) said dispensing device has plurality of non-slip screw-on ports for needles.

13. The self-help method of liquid medication dispensing system of claim 11 wherein said dispensing embodiment comprises embodiment of FIG. 7.

14. The self-help method of liquid medication dispensing system of claim 11 wherein said dispensing embodiment comprises embodiment of FIG. 8.

15. The self-help method of liquid medication dispensing system of claim 11 wherein said dispensing embodiment comprises embodiment of FIG. 9.

16. The self-help method of liquid medication dispensing system of claim 11 wherein said dispensing embodiment comprises embodiment of FIG. 10.

17. The self-help method of liquid medication dispensing system of claim 11 wherein said dispensing device is a syringe.

18. The personal medication dispensing system for pain relief of claim 1 wherein said dispensing device comprises embodiment of FIG. 10.

19. The self-help method of liquid medication dispensing system of claim 11 wherein said liquid medicine comprises blue label 1% Lidocaine.

20. The self-help method of liquid medication dispensing system of claim 11 wherein said liquid medicine comprises red label Cortisone with both cortisone and lidocaine.
